(19) United States
(12) Patent Application Publication
(10) Pub. No.: US 2025/0390664 A1
(43) Pub. Date: Dec. 25, 2025

(54) SYSTEMS AND METHODS FOR DYNAMIC LOCAL RELOCATION ACUMEN

(71) Applicant: Julie Ann Kubat, Clayton, MO (US)

(72) Inventor: Julie Ann Kubat, Clayton, MO (US)

(21) Appl. No.: 18/748,438

(22) Filed: Jun. 20, 2024

Related U.S. Application Data
(60) Provisional application No. 63/497,564, filed on Apr. 21, 2023.

(51) Int. Cl. G06F 40/166; G06F 16/29; G06F 16/93; G06F 40/103

(52) U.S. Cl. CPC G06F 40/166; G06F 16/29; G06F 16/94; G06F 40/103

(57) ABSTRACT

A computer system for building dynamic local relocation acumen using large language models may be provided. The computer system may be programmed to (i) receive, from a user computer device, a selection of a location; (ii) retrieve, from one or more remote servers, information about the selected location; (iii) retrieve, from one or more remote servers, a plurality of images of the selected location; (iv) execute at least one model to output a location guide using the information about the selected location and the plurality of images of the selected location; (v) receive as output of the execution of the at least one model the location guide for the selected location; and/or (vi) transmit instructions to a user computer device to display the location guide on the user computer device.

### CROSS REFERENCE TO RELATED APPLICATIONS

This application claims priority to U.S. Provisional Patent Application No. 63/497,564, filed Apr. 21, 2023, which is hereby incorporated by reference in its entirety.

### FIELD OF THE DISCLOSURE

The present disclosure relates generally to dynamic local relocation acumen, and more particularly, to a network-based system and method that uses models to analyze neighborhoods and to generate dynamic analysis reports with supporting and explanatory information.

### BACKGROUND

When analyzing neighborhoods, there is a significant amount of data that needs to be collected from a large number of different computer systems, including, but not limited to, demographic information, municipal information, school information, and/or event information. Furthermore, this information may be in multiple different non-compatible formats. Accordingly, it would be advisable to have a system that collects, converts, and collates this data into a single location and format to allow for easier user access.

### BRIEF SUMMARY

The present embodiments may relate to, inter alia, a system analysis tool to analyze neighborhoods and to generate dynamic analysis reports with supporting and explanatory information. Further, the present embodiments may relate to building, simulating, and validating a machine learning model, and more particularly, to a network-based system and computer-implemented method that uses large language models to dynamically build neighborhood guides based on user preferences. The computer systems and computer-implemented methods described herein may provide for advanced decision-making and designing visual displays for user engagement. The computer systems also provide for placing QR codes and/or hyperlinks into the guides and tracking the usage of the QR codes and/or hyperlinks.

In one aspect, a computer system for dynamic local relocation acumen using large language models may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include a computing device that may include at least one processor in communication with at least one memory device. The at least one processor may be configured to: (i) receive, from a user computer device, a selection of a location; (ii) retrieve, from one or more remote servers, information about the selected location; (iii) retrieve, from one or more remote servers, a plurality of images of the selected location; (iv) execute at least one model to output a location guide using the information about the selected location and the plurality of images of the selected location; (v) receive as output of the execution of the at least one model the location guide for the selected location; and/or (vi) transmit instructions to a user computer device to display the location guide on the user computer device. The computer system may include additional, less, or alternate functionality, including that discussed elsewhere herein.

In another aspect, a computer-implemented method for dynamic local relocation acumen using large language models may be provided. The computer-implemented method may be performed by a computer device including at least one processor in communication with at least one memory device. The method may include: (i) receive, from a user computer device, a selection of a location; (ii) retrieve, from one or more remote servers, information about the selected location; (iii) retrieve, from one or more remote servers, a plurality of images of the selected location; (iv) execute at least one model to output a location guide using the information about the selected location and the plurality of images of the selected location; (v) receive as output of the execution of the at least one model the location guide for the selected location; and/or (vi) transmit instructions to a user computer device to display the location guide on the user computer device. The computer-implemented method may include additional, less, or alternate actions, including those discussed elsewhere herein.

In another aspect, at least one non-transitory computer-readable media having computer-executable instructions embodied thereon may be provided. When executed by a computing device including at least one processor in communication with at least one memory device, the computer-executable instructions may cause the at least one processor to: (i) receive, from a user computer device, a selection of a location; (ii) retrieve, from one or more remote servers, information about the selected location; (iii) retrieve, from one or more remote servers, a plurality of images of the selected location; (iv) execute at least one model to output a location guide using the information about the selected location and the plurality of images of the selected location; (v) receive as output of the execution of the at least one model the location guide for the selected location; and/or (vi) transmit instructions to a user computer device to display the location guide on the user computer device. The computer-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates an exemplary computer system for dynamic local relocation acumen using large language models, in accordance with at least one embodiment.

FIG. 2 illustrates an exemplary computer-implemented or computer-based process for dynamic local relocation acumen using large language models, using the system shown in FIG. 1.

FIG. 3 illustrates an exemplary computer system for performing the processes shown in FIG. 2.

FIG. 4 is a schematic diagram of an exemplary local relocation acumen (LRA) server shown in FIG. 1, that may be used with the systems shown in FIGS. 1 and 3.

FIG. 5 illustrates an exemplary configuration of a user computer device, in accordance with one embodiment of the present disclosure.

FIG. 6 illustrates an exemplary configuration of a server computer device, in accordance with one embodiment of the present disclosure.

FIG. 7 illustrates an exemplary user interface for a location guide, in accordance with at least one embodiment.

FIG. 8 illustrates another exemplary user interface for a location guide, in accordance with at least one embodiment.

FIG. 9 illustrates a further exemplary user interface for a location guide, in accordance with at least one embodiment.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present disclosure relates generally to dynamic local relocation acumen, and more particularly, to a network-based system and method that uses models to analyze neighborhoods and to generate dynamic analysis reports with supporting and explanatory information. In one exemplary embodiment, the process may be performed by a local relocation acumen (LRE) computer device. In the exemplary embodiment, the LRA computer device may be in communication with one or more client devices, one or more third-party servers, one or more imagery servers, and one or more image enhancement systems.

As described below in further detail, the LRA computer device includes one or more large language models (LLM), such as GPT (Generative Pre-trained Transformers) models, and one or more supplemental models that are configured to curate data from third-party servers to generate a local acumen guide based on provided information and location selection(s). The LRA computer device sends information (both historical and current) to the one or more GPT models for either training the GPT models or inputting the curated data to an already trained model for generating a guide as output. The one or more supplemental models are configured to monitor and enhance images to improve the quality and lighting of images to match the desired image quality and other settings.

In the exemplary embodiment, the LRA computer device is configured to execute a tool created to inform and motivate multiple types of entities as it relates to either evaluating and/or moving to a new place and acquiring housing, or enticing a party to relocate to a new area. In the exemplary embodiment, the LRA computer device combines housing data/statistics, community details/amenities, and recommended area resources, provided at a micro or macro level, to create a unique collection/sum of information and intellectual property that an end user might consider valuable when analyzing or executing a relocation endeavor or for the purpose of buying or selling real estate.

In the exemplary embodiment, the LRA computer device is configured to generate a publication (guide) in both a print format and digital format. The Publication can be free-standing or part of a collection. The digital format offers embedded hyperlinks to subsequent organizations or resources.

In the exemplary embodiment, the LRA computer device is configured to design the guide to solicit to and to inform new area residents, curious local residents, potential real-estate buyers, and/or potential real estate sellers. Furthermore, the LRA computer is configured to design the guide to attract advertisers, recruiting businesses, relocation candidates, and/or potential real estate sellers. Furthermore, the guide is also configured to provide a user-friendly interface to assist new area residents and relocation candidates in the on-boarding relocation process.

In the exemplary embodiment, the LRA computer device is in communication with one or more databases configured to store information including, but not limited to, publication templates, industry content supplements, analytics of hyperlink activity, production practices, additional resources, and/or hosted digital publications.

In some embodiments, the LRA computer device allows a user to make one or more selections for the content of the guide. Then the LRA computer device builds out the guide based upon the one or more selections. This may include collecting data from a plurality of third-party servers. This allows the system and/or user to partner with one or more recruiting entities and to showcase property listings. In some further embodiments, the user is able to offer or sell advertising to be shown in the guide. The guide is designed to attract (relocation) property buyers and to draw attention of the local residents.

In some embodiments, the LRA computer system captures the name, email, and current zip code information for users of the digital or online guide. Furthermore, the LRA computer system traces and tracks the usage of QR codes in the print guide and/or hyperlinks in the digital guide. This usage data may be added to generic or specific analytics. Furthermore, the data may review the recurrence of user visits, links selected, and the frequency of activity for those QR codes and hyperlinks.

In the exemplary embodiment, the LRA computer system builds the guide with photos, videos, QR codes, and/or hyperlinks. In some embodiments, the LRA computer system generates the guide with a plurality of components, this plurality of components may include, but it not limited to, welcome and area overview, community or neighborhood maps with matching property search links, community or neighborhood specific sold housing price statistics, community or neighborhood features or highlands, photos or videos depicting specific community or neighborhoods, consolidated summaries of area schools with photos, videos and local youth activities, club sports, and programs, housing developments, builder/contractor forum, temporary housing information and data, area calendar of events with details, area features and amenities, vetted and extensive resource list of area businesses and services, financing and lending forum, life and community safety data and stats, community initiatives, and/or all levels of local government representatives.

In the exemplary embodiment, the LRA computer system receives a selection of a geographic location from a user from a user computer device. Then LRA computer system accesses multiple third-party servers, such as, but not limited to, a real-estate server, a local government server, and/or a local school server. The LRA computer system receives data from the plurality of third-party servers about the selected location. The LRA computer system collects image data from one or more imagery servers. Then the LRA computer system enhances the images by using one or more image enhancement systems. Then the LRA computer system generates a guide using the retrieved information and the enhanced images. In at least one embodiment, the LRA computer system builds a plurality of components for guide. In these embodiments, the LRA computer system may receive instructions for one or more components to be added to the guide along with the selection of the geographic location. The LRA system may also access one or more user preferences for the user to determine one or more components to add to the guide.

In the exemplary embodiment, the LRA computer system trains one or more models with graphic and imaging styles based on different location. The LRA computer system trains the one or more models to generate guides tailored for the location. In these embodiments, the LRA computer system receives a plurality of historical guides along with feedback on the different parts of the guides to generate a model capable of generating high quality guides. Furthermore, the LRA computer system is configured to continue to update and train the models based on feedback of created guides. In some further embodiments, the LRA computer system trains the models to generate guides for different geographic regions of the country to include regional charm and appeal. In the exemplary embodiment, the models are large language models (LLM), such as GPT (Generative Pre-trained Transformers) models.

### Exemplary Analysis System

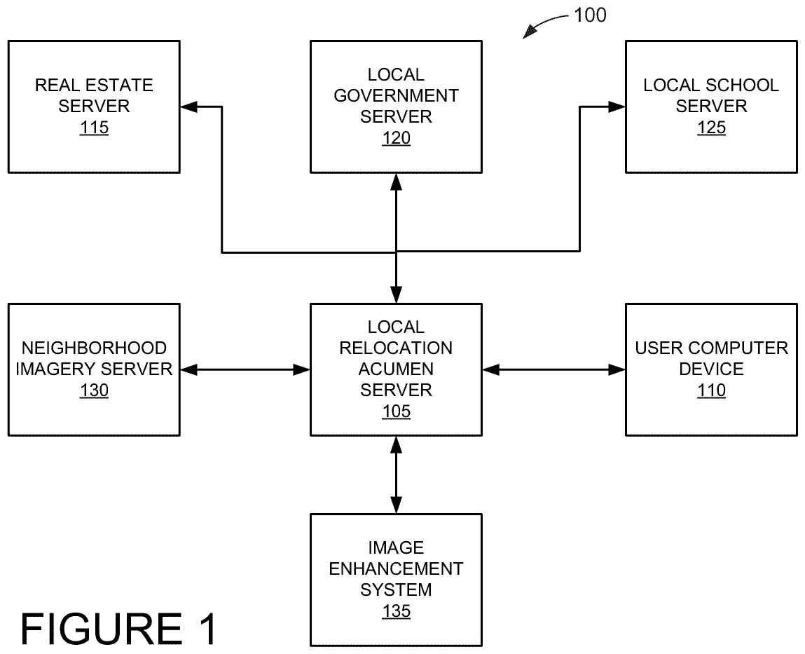

FIG. 1 illustrates an exemplary computer system 100 for dynamic local relocation acumen using large language models, in accordance with at least one embodiment of the present disclosure. The dynamic local relocation acumen system 100 is configured to dynamically build relocation guides based upon user input and current and historical information about a location, such as a city, a town, a village, a county, a region, an apartment complex, a housing community, a neighborhood, a borough, and/or any other geographic location.

In the exemplary embodiment, the system 100 may include a local relocation acumen (LRA) server 105 (also known as a LRA computer device 105). The LRA sever 105 may include one or more locally trained large language models (LLM) for generating a guide. In at least one embodiment, the large language models may be GPT (Generative Pre-trained Transformers) models.

In the exemplary embodiment, the LRA server 105 is in communication with one or more user computer devices 110. The LRA server 105 is configured to receive data from the user computer devices 110 such as with a selection of a location to generate a guide about. The user computer devices 110 may also provide user preferences or other information to be included in the guide to be designed.

In the exemplary embodiment, the LRA server 105 collects data from a plurality of sources about the selected location. These sources may include, but are not limited to, real estate servers 115, local government servers 120, local school servers 125, and/or any other third-party server 315 that may provide information as needed.

In the exemplary embodiment, the LRA server 105 also collects image data of the selected location. In some embodiments, the LRA server 105 collects image data from one or more neighborhood imagery servers 130. In at least one embodiment, the neighborhood imagery server 130 includes a mapping server that has mapped streets and surroundings in the selected location. The one or more neighborhood imagery servers 130 may include photos of the location, of the homes in the area, of parks and other recreation locations, of restaurants, of shopping areas, of landmarks, and/or any other images that the LRA server 105 is able to or instructed to acquire. In some of these embodiments, the LRA server 105 is also in communication with one or more image enhancement system 135, that allow the LRA server 105 to provide images that the image enhancement systems 135 update, modify, enhance, and/or otherwise improve the images and/or image quality.

In the exemplary embodiment, the LRA server 105 combines housing data/statistics, community details/amenities, and recommended area resources, provided at a micro or macro level, to create a unique collection/sum of information and intellectual property that an end user might consider valuable when analyzing or executing a relocation endeavor or for the purpose of buying or selling real estate. More specifically, the LRA server 105 builds a plurality of components for guide. In these embodiments, the LRA server 105 may receive instructions for one or more components to be added to the guide along with the selection of the geographic location. The LRA server 105 may also access one or more user preferences for the user to determine one or more components to add to the guide.

The LRA server 105 builds the guide with photos, videos, QR codes, and/or hyperlinks. In some embodiments, the LRA server 105 generates the guide with a plurality of components, this plurality of components may include, but it not limited to, welcome and area overview, community or neighborhood maps with matching property search links, community or neighborhood specific sold housing price statistics, community or neighborhood features or highlands, photos or videos depicting specific community or neighborhoods, consolidated summaries of area schools with photos, videos and local youth activities, club sports, and programs, housing developments, builder/contractor forum, temporary housing information and data, area calendar of events with details, area features and amenities, vetted and extensive resource list of area businesses and services, financing and lending forum, life and community safety data and stats, community initiatives, and/or all levels of local government representatives.

In some embodiments, the LRA server 105 allows a user to make one or more selections for the content of the guide. Then the LRA server 105 builds out the guide based upon the one or more selections. This may include collecting data from a plurality of third-party servers. This allows the system and/or user to partner with one or more recruiting entities and to showcase property listings. In some further embodiments, the user is able to offer or sell advertising to be shown in the guide. The guide is designed to attract (relocation) property buyers and to draw attention of the local residents.

In some embodiments, the LRA server 105 captures the name, email, and current zip code information for users of the digital or online guide. Furthermore, the LRA server 105 traces and tracks the usage of QR codes in the print guide and/or hyperlinks in the digital guide. This usage data may be added to generic or specific analytics. Furthermore, the data may review the recurrence of user visits, links selected, and the frequency of activity for those QR codes and hyperlinks.

In the exemplary embodiment, the LRA server 105 trains one or more models with graphic and imaging styles based on different location. The LRA server 105 trains the one or more models to generate guides tailored for the location. In these embodiments, the LRA server 105 receives a plurality of historical guides along with feedback on the different parts of the guides to generate a model capable of generating high quality guides. Furthermore, the LRA server 105 is configured to continue to update and train the models based on feedback of created guides. In some further embodiments, the LRA server 105 trains the models to generate guides for different geographic regions of the country to include regional charm and appeal. In the exemplary embodiment, the models are large language models (LLM), such as GPT (Generative Pre-trained Transformers) models.

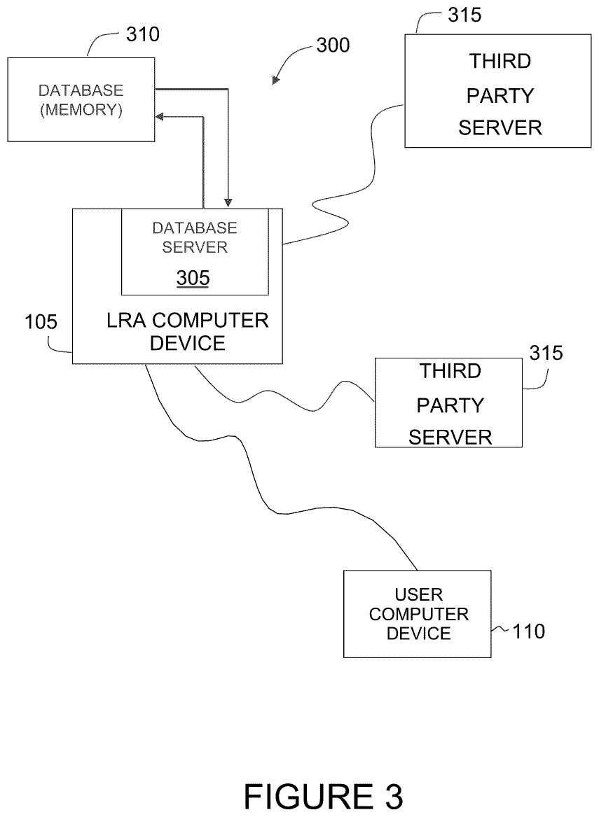

In some embodiments, the LRA server 105 places QR codes and/or hyperlinks into the guide. These QR codes and/or hyperlinks link back to third-party servers 315 (shown in FIG. 3) and/or to the LRA server 105 to provide additional information. The LRA server 105 tracks the usage of the QR codes and/or hyperlinks and provides feedback on the usage to at least one of the users and/or the one or more models for generating the guide, so that the model(s) will update based on the usage numbers. In some embodiments, the additional information on the LRA server 105 is generated by the one or more models to provide additional information that was not provided in the guide. The LRA server 105 and/or the model(s) may determine which information to put in the guide vs. online based on previous user engagement with the information. In other embodiments, the LRA server 105 monitors the usage of the digital guides and provides that usage information to the user and/or the models.

In some embodiments, the LRA server 105 hosts the completed guides and receives requests to view those guides from user computer devices 110. In some of these embodiments, the LRA server 105 hosts the guides on a webpage or other web-based hosting, where the LRA server 105 transmits instructions to display the current page(s) of the guide on the user computer device 110. In other embodiments, the LRA server 105 provides an application that allows users to view the guides on their user computer devices 110.

### Exemplary Rate Analysis Process

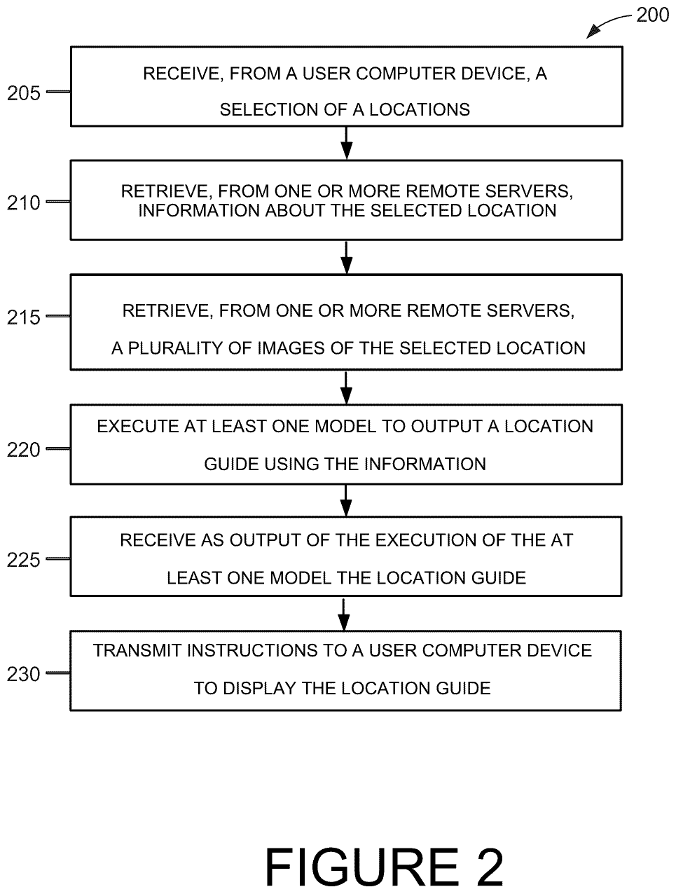

FIG. 2 illustrates an exemplary computer-implemented or computer-based process 200 for dynamic local relocation acumen using large language models, using the system 100 (shown in FIG. 1). In the exemplary embodiment, the functionality or operations of process 200 may be performed by the LRA server 105 (shown in FIG. 1) in communication with one or more user computer devices 110 (shown in FIG. 1), and/or one or more third party servers 315 (shown in FIG. 3.

In the exemplary embodiment, the LRA computer system 105 is configured to receive 205, from a user computer device 110, a selection of a location. The location may include the location is a geographic location including at least one of a city, a town, a village, a county, a region, an apartment complex, a housing community, a neighborhood, a borough, and/or any other geographic location.

In the exemplary embodiment, the LRA computer system 105 retrieves 210, from one or more remote servers 315 (shown in FIG. 3), information about the selected location. The one or more remote servers 315 provide local information about the selected location. The local information includes at least one of demographic information, municipal information, school information, and/or event information.

In the exemplary embodiment, the LRA computer system 105 retrieve 215, from one or more remote servers 315, a plurality of images of the selected location. The plurality of images of the selected location are provided by a mapping server, such as neighborhood imagery server 130 (shown in FIG. 1).

In the exemplary embodiment, the LRA computer system 105 executes 220 at least one model to output a location guide using the information about the selected location and the plurality of images of the selected location. In some embodiments, the LRA computer system 105 enhances the quality of one or more images of the plurality of images of the selected location, such a via an image enhancement system 135 (shown in FIG. 1).

In the exemplary embodiment, the LRA computer system 105 receives 225 as output of the execution of the at least one model the location guide for the selected location.

In the exemplary embodiment, the LRA computer system 105 transmits 230 instructions to a user computer device 110 to display the location guide on the user computer device 110.

In some embodiments, the LRA computer system 105 receives a plurality of historical guides and a plurality of information associated with the plurality of historical guides. The LRA computer system 105 trains the at least one model to generate guides based upon the plurality of historical guides and the plurality of information associated with the plurality of historical guides. The LRA computer system 105 also stores the at least one model.

In some further embodiments, the LRA computer system 105 adds a plurality of links to the location guide, wherein the plurality of links provide access to additional information. The LRA computer system 105 hosts the additional information. When activated the links cause the LRA computer system 105 to transmit instructions to display one or more items of the additional information on the user computer device 110. The links may include at least one of a QR code and a hyperlink.

### Exemplary Computer System

FIG. 3 illustrates an exemplary computer system 300 for performing the process 200 (shown in FIG. 2). In the exemplary embodiment, the system 300 may be used for dynamic local relocation acumen using large language models (LLM).

As described below in more detail, the local relocation acumen (LRA) computer system 105 may be programmed for generating LRA guides. In addition, the LRA computer system 105 may be programmed to coordinate the communication and execute of large language models (LLM) to generate LRA guides. In some embodiments, the LRA computer system 105 may be programmed to (i) receive, from a user computer device 110, a selection of a location; (ii) retrieve, from one or more remote servers 315, information about the selected location; (iii) retrieve, from one or more remote servers 315, a plurality of images of the selected location; (iv) execute at least one model to output a location guide using the information about the selected location and the plurality of images of the selected location; (v) receive as output of the execution of the at least one model the location guide for the selected location; and/or (vi) transmit instructions to a user computer device 110 to display the location guide on the user computer device 110. The computer system may include additional, less, or alternate functionality, including that discussed elsewhere herein.

In the exemplary embodiment, user computer devices 110 may be computers or computing devices that include a web browser or a software application, which enables user computer devices 110 to communicate with LRA computer system 105 using the Internet, a local area network (LAN), or a wide area network (WAN). In some embodiments, the user computer devices 110 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. User computer devices 110 may be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices. User computer devices 110 are used by users how are having the guides built as well by users who are viewing the guides.

In the exemplary embodiment, the LRA computer system 105 (also known as LRA server 105) may be a computer that includes a web browser or a software application, which enables LRA computer system 105 to communicate with user computer devices 110 using the Internet, a local area network (LAN), or a wide area network (WAN). In some embodiments, the LRA computer system 105 may be communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. LRA computer system 105 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

A database server 305 may be communicatively coupled to a database 310 that stores data. In one embodiment, the database 310 may be a database that includes one or more large language models, publication templates, industry content supplements, analytics of hyperlink activity, production practices, additional resources, and/or hosted digital publications. In some embodiments, the database 310 is stored remotely from the LRA computer system 105. In some embodiments, the database 310 is decentralized. In the exemplary embodiment, a person may access the database 310 via the user computer devices 110 by logging onto LRA computer system 105.

Third-party servers 315 may be any third-party server that LRA computer system 105 is in communication with that provides additional functionality and/or information to LRA computer system 105. For example, third-party server 315 may include real-estate server 115, local government server 120, and/or local school server 125 (all shown in FIG. 1).

In the exemplary embodiment, third-party servers 315 may be computers that include a web browser or a software application, which enables third-party servers 315 to communicate with LRA computer system 105 using the Internet, a local area network (LAN), or a wide area network (WAN). In some embodiments, the third-party server 315 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Third-party servers 315 may be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

### Exemplary Server Device

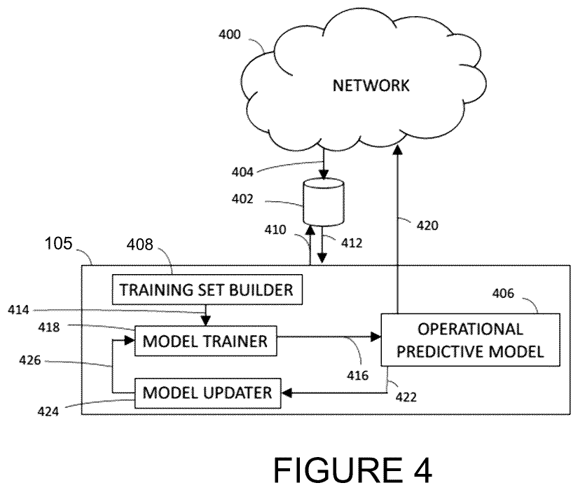

FIG. 4 is a schematic diagram of an exemplary dynamic local relocation acumen (LRA) server 105 (shown in FIG. 1), that may be used with the systems 100 and 300 (shown in FIGS. 1 and 3). LRA server 105 may communicate with other components of system 300, such as third-party servers 315 (shown in FIG. 3), user computer devices 110, real estate server 115, local government server 120, local school server 125, and/or neighborhood imagery server 130 (all shown in FIG. 1), via a network 400.

LRA server 105 may include and/or be in communication with a database 402 that stores data 404, such as database 310 (shown in FIG. 3), stored records generated by LRA server 105, and/or any other relevant data as described herein. Data 404 received from network 400 may be stored in database 402. LRA server 105 may configured to use data 404 to generate an operational large language model module 406 for controlling operations of LRA server 105 (e.g., in accessing third-party databases via a digital portal), predicting outcomes of claims, generating action recommendations in response to operational requests, and the like. As described above, operational LLM module 406 may include at least one processor configured to: analyze one or more predictive pricing sub-models to detect one or more issues with the one or more predictive pricing sub-models, and execute the LLM that is trained to identify differences between predicted pricing and actual pricing for insurance related events, and/or identify data elements potentially related to the pricing differential including, but not limited to, claims history, vehicle history, prior insurance history, and/or public records. The operational LLM module 406 may also compare the one or more issues to one or more outputs of the LLM model, and in response to the comparison, generate a new model software template including one or more code changes to the one or more predictive pricing sub-models based upon the comparison. The LLM module 406 may then deploy the new model in a simulation environment, and execute the new model software template in the simulation environment. The operational LLM module 406 may then update the new model software template based upon one or more outputs of the execution.

In exemplary embodiments, LRA server 105 may include a training set builder module 408 configured to submit one or more queries 410 to database 402 to retrieve subsets 412 of data 404, and to use those subsets 412 to build training data sets 414 for generating operational large language model 406. For example, query 410 may be configured to retrieve certain fields from data 404 for a specific vehicle, a specific asset, specific category of assets, a specific type of insurance coverage, a category of persons, a health-related category, and/or any other division of factors desired by the user and/or for compliance, such as with a government entity.

In various embodiments, training set builder module 408 may be configured to derive training data sets 414 from retrieved subsets 412. Each training data set 414 corresponds to a historical data 404 (“historical” in this context means completed in the past, as opposed to completed in real-time with respect to the time of retrieval). Each training data set 414 may include “model input” data fields along with at least one “result” data field representing a historical outcome associated with the model input. The model input data fields represent factors that may be expected to, or unexpectedly be found during model training to, have some correlation.

In exemplary embodiments, the model input data fields in training data sets 414 may be generated from data fields in subset 412 corresponding to historical data 404. In other words, a trained machine learning model 416 produced by a model trainer module 418 for use by operational predictive model module 406 is trained to make predictions based upon input values that can be generated from the data fields in data 404. Values in the model input data fields may include values copied directly from values in a corresponding data field in the retrieved subset 412, and/or values generated by modifying, combining, or otherwise operating upon values in one or more data fields in the retrieved subset 412. The use of such data fields as model input data fields facilitates the machine learning model in weighing these factors directly.

After training set builder module 408 generates training data sets 414, training set builder module 408 passes the training data sets 414 to model trainer module 418. In certain embodiments, model trainer module 418 may be configured to apply the model input data fields of each training data set 414 as inputs to one or more machine learning models. Each of the one or more machine learning models may be programmed to produce, for each training data set 414, at least one output intended to correspond to, or “predict,” a value of the at least one result data field of the training data set 414. “Machine learning” refers broadly to various algorithms that may be used to train the model to identify and recognize patterns in existing data in order to facilitate making predictions for subsequent new input data.

Model trainer module 418 may be configured to compare, for each training data set 414, the at least one output of the model to the at least one result data field of the training data set 414, and apply a machine learning algorithm to adjust parameters of the model in order to reduce the difference or “error” between the at least one output and the corresponding at least one result data field. In this way, model trainer module 418 trains the machine learning model to accurately predict the value of the at least one result data field.

In other words, model trainer module 418 cycles the one or more machine learning models through the training data sets 414, causing adjustments in the model parameters, until the error between the at least one output and the at least one result data field falls below a suitable threshold, and then uploads at least one trained machine learning model 416 to operational large language model module 406 for application to generating recommendations 420. In exemplary embodiments, model trainer module 418 may be configured to simultaneously train multiple candidate machine learning models and to select the best performing candidate for each result data field, as measured by the “error” between the at least one output and the corresponding result data field, to upload to operational predictive model module 406.

In certain embodiments, the one or more machine learning models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer.

As model trainer module 418 cycles through the training data sets 414, model trainer module 418 applies a suitable backpropagation algorithm to adjust the weights in each node layer to minimize the error between the at least one output and the corresponding result data field. In this fashion, the machine learning model is trained to produce output that reliably predicts the corresponding result data field. Alternatively, the machine learning model may have any suitable structure.

In some embodiments, model trainer module 418 may provide an advantage by automatically discovering and properly weighting complex, second- or third-order, and/or otherwise nonlinear interconnections between the model input data fields and the at least one output. Absent the machine learning model, such connections are unexpected and/or undiscoverable by human analysts.

The LRA server 105 of the present disclosure may be configured to operate on input data related to predictive pricing models including to build, simulate, and validate a predictive pricing model and/or sub-model for calculating insurance rates for an insurance product. In one exemplary embodiment, LRA server 105 executes the operational large language model module 402 programmed to learn, without limitation, outcomes of claims based upon varying events and details, relevant data sources for evidence, the queries used to prompt a user to provide relevant information, features of claims or evidence related to potential fraud, and the like.

To facilitate this learning, LRA server 105 may include one or more databases 402 at which the data, including data as well as responses, evidence, outcomes, etc., is stored. This data becomes one or more input training sets used by the training set builder 408. Model outputs can be formatted for presentation or review as visual representations of recommendations, as text-based or natural language recommendations, and the like. In exemplary embodiments, operational predictive model module 406 may compare feedback, and may route a comparison result 422 generated by comparing recommendation 420 to the feedback to a model updater module 424 of LRA server 105. Model updater module 424 is configured to derive a correction signal 426 from comparison results 422 received for one or more recommendations, and to provide correction signal 426 to model trainer module 418 to enable updating or “re-training” of the at least one machine learning model to improve performance. The retrained at least one machine learning model 416 may be periodically re-uploaded to operational predictive model module 406.

### Exemplary Client Device

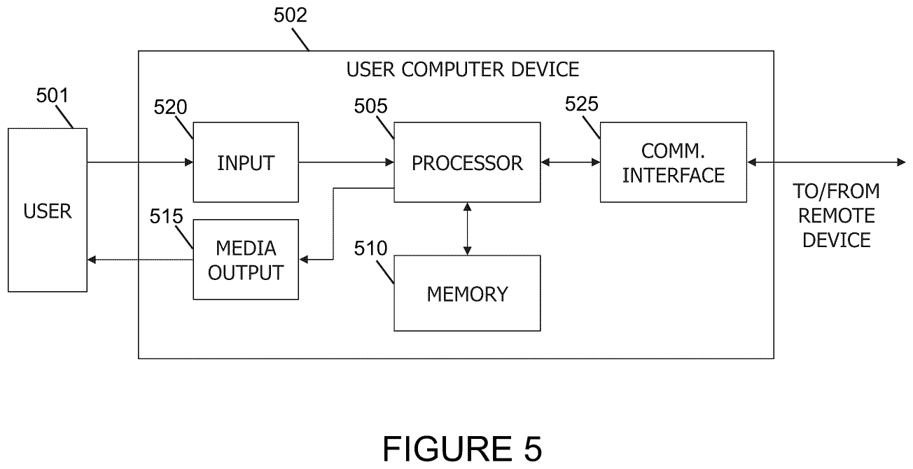

FIG. 5 depicts an exemplary configuration 500 of user computer device 502, in accordance with one embodiment of the present disclosure. In the exemplary embodiment, user computer device 502 may be similar to, or the same as, user computer device 110 (shown in FIG. 1). User computer device 502 may be operated by a user 501.

User computer device 502 may include a processor 505 for executing instructions. In some embodiments, executable instructions may be stored in a memory area 510. Processor 505 may include one or more processing units (e.g., in a multi-core configuration). Memory area 510 may be any device allowing information such as executable instructions and/or transaction data to be stored and retrieved. Memory area 510 may include one or more computer readable media.

User computer device 502 may also include at least one media output component 515 for presenting information to user 501. Media output component 515 may be any component capable of conveying information to user 501. In some embodiments, media output component 515 may include an output adapter (not shown) such as a video adapter and/or an audio adapter. An output adapter may be operatively coupled to processor 505 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 515 may be configured to present a graphical user interface (e.g., a web browser and/or a client application) to user 501. A graphical user interface may include, for example, an interface for viewing items of information provided by the MTA computer system 110 (shown in FIG. 1). In some embodiments, user computer device 502 may include an input device 520 for receiving input from user 501. User 501 may use input device 520 to, without limitation, provide information either through speech or typing.

Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device such as MTA computer system 110. Communication interface 525 may include, for example, a wired or wireless network adapter and/or a wireless data transceiver for use with a mobile telecommunications network.

Stored in memory area 510 are, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from MTA computer system 110. A client application may allow user 501 to interact with, for example, MTA computer system 110. For example, instructions may be stored by a cloud service, and the output of the execution of the instructions sent to the media output component 515.

### Exemplary Server Device

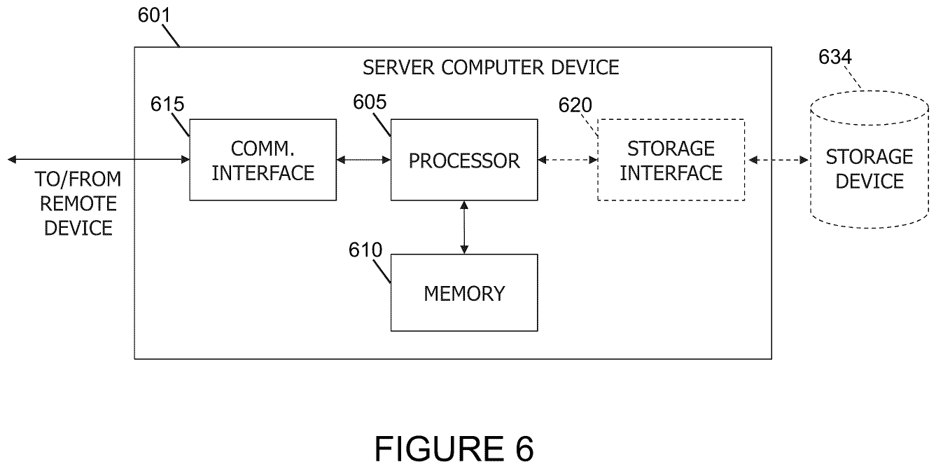

FIG. 6 depicts an exemplary configuration 600 of a server computer device 601, in accordance with one embodiment of the present disclosure. In the exemplary embodiment, server computer device 601 may be similar to, or the same as, LRA computer system 105, real estate server 115, local government server 120, local school server 125, neighborhood imagery server 130, image enhancement system 135 (all shown in FIG. 1), database server 305, and third-party server 315 (both shown in FIG. 3). Server computer device 601 may also include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 601 is capable of communicating with a remote device such as another server computer device 601, MTA computer system 110, third-party servers 315, and client devices 145 (shown in FIG. 1) (for example, using wireless communication or data transmission over one or more radio links or digital communication channels). For example, communication interface 615 may audio input from client devices 145 via the Internet, as illustrated in FIG. 3.

Processor 605 may also be operatively coupled to a storage device 634. Storage device 634 may be any computer-operated hardware suitable for storing and/or retrieving data, such as, but not limited to, data associated with one or more models. In some embodiments, storage device 634 may be integrated in server computer device 601. For example, server computer device 601 may include one or more hard disk drives as storage device 634.

In other embodiments, storage device 634 may be external to server computer device 601 and may be accessed by a plurality of server computer devices 601. For example, storage device 634 may include a storage area network (SAN), a network attached storage (NAS) system, and/or multiple storage units such as hard disks and/or solid-state disks in a redundant array of inexpensive disks (RAID) configuration.

In some embodiments, processor 605 may be operatively coupled to storage device 634 via a storage interface 620. Storage interface 620 may be any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 634.

Processor 605 may execute computer-executable instructions for implementing aspects of the disclosure. In some embodiments, the processor 605 may be transformed into a special purpose microprocessor by executing computer-executable instructions or by otherwise being programmed. For example, the processor 605 may be programmed with the instruction such as illustrated in FIG. 2.

### Exemplary User Interfaces

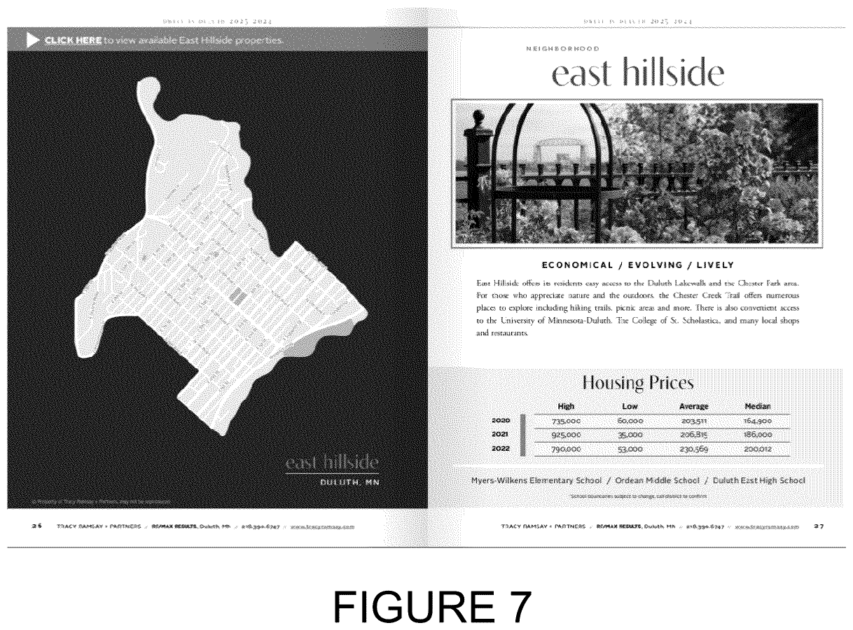

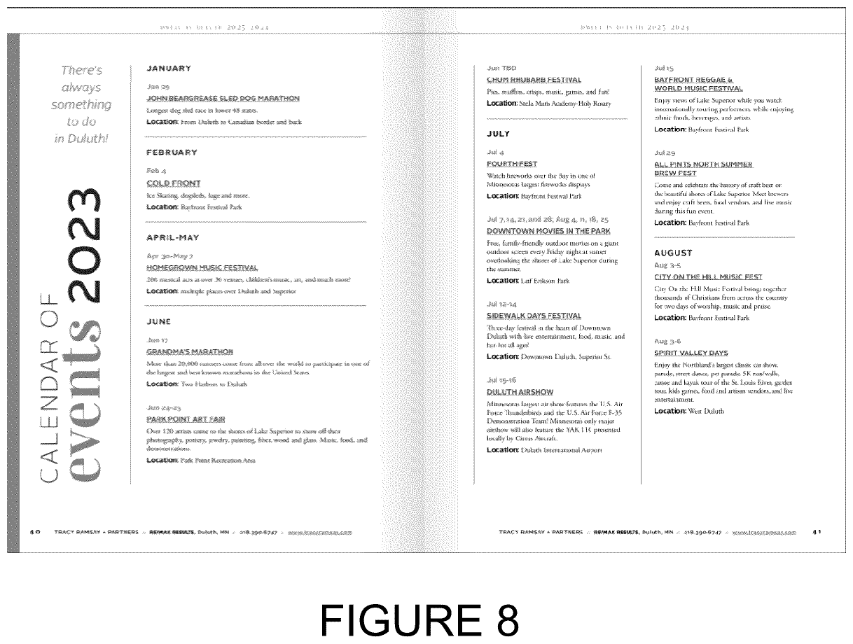

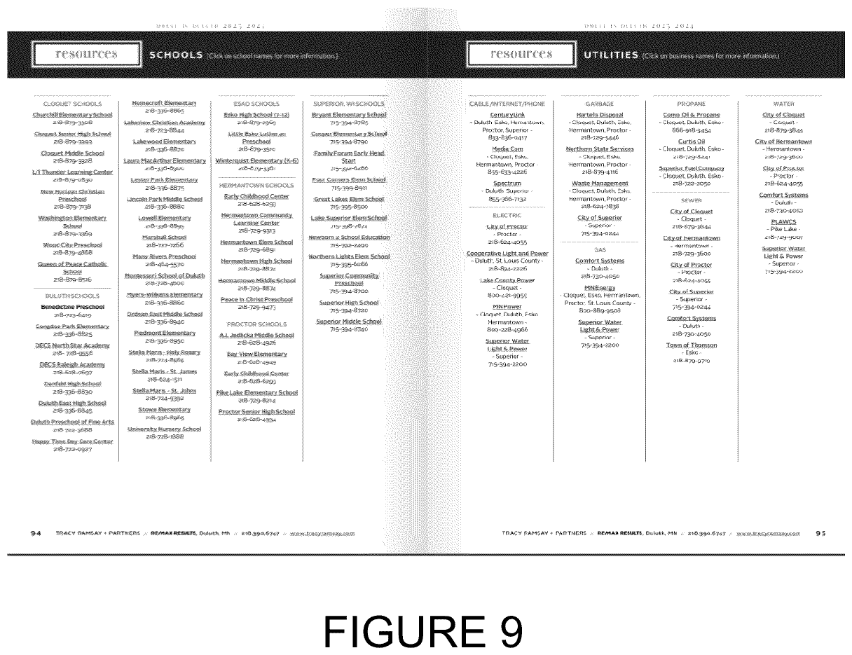

FIGS. 7-9 illustrate exemplary user interfaces for a location guide, in accordance with at least one embodiment. The exemplary user interfaces include a neighborhood overview component, a local events component, and a local resources component showing schools and utilities associated with the location.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, LRA computer system 105 is configured to implement machine learning, such that LRA computer system 105 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images, text data, and/or other types of data. ML outputs may include, but are not limited to identified objects, items classifications, textual product, and/or other data extracted from the images or textual data. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of text with known characteristics or features. Such information may include, for example, information associated with a plurality of text of a plurality of different vendors, data sources, objects, items, and/or property.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to generating guides. The processing element may also learn how to identify attributes of different configurations of guides in view of feedback. This information may be used to determine which components to use and how to generate said guides.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, NoSQL, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer system for building dynamic local relocation and domicile acumen using large language models, the system including at least one processor in communication with at least one memory device, the at least one processor programmed to:
receive, from a user computer device, a selection of a location;
retrieve, from one or more remote servers, information about the selected location;
retrieve, from one or more remote servers, a plurality of images of the selected location;
execute at least one model to output a location guide using the information about the selected location and the plurality of images of the selected location;
receive as output of the execution of the at least one model the location guide for the selected location; and
transmit instructions to a user computer device to display the location guide on the user computer device.

2. The computer system of claim 1, wherein the location is a geographic location including at least one of a city, a town, a village, a county, a region, an apartment complex, a housing community, a neighborhood, and/or a borough.

3. The computer system of claim 1, wherein the one or more remote servers provide local information about the selected location.

4. The computer system of claim 1, wherein the local information includes at least one of demographic information, municipal information, school information, and/or event information.

5. The computer system of claim 1, wherein the plurality of images of the selected location are provided by a mapping server.

6. The computer system of claim 1, wherein the at least one processor is further programmed to enhance the quality of one or more images of the plurality of images of the selected location.

7. The computer system of claim 1, wherein the at least one processor is further programmed to:
receive a plurality of historical guides and a plurality of information associated with the plurality of historical guides;
train the at least one model to generate guides based upon the plurality of historical guides and the plurality of information associated with the plurality of historical guides; and
store the at least one model.

8. The computer system of claim 1, wherein the at least one processor is further programmed to add a plurality of links to the location guide, wherein the plurality of links provide access to additional information.

9. The computer system of claim 8, wherein the at least one processor is further programmed to host the additional information, wherein when activated the links cause the at least one processor to transmit instructions to display one or more items of the additional information on the user computer device.

10. The computer system of claim 8, wherein the links include at least one of a QR code and a hyperlink.

11. A computer-implemented method implemented by a computer system including at least one processor in communication with at least one memory device, the method comprising:
receiving, from a user computer device, a selection of a location;
retrieving, from one or more remote servers, information about the selected location;
retrieving, from one or more remote servers, a plurality of images of the selected location;
executing at least one model to output a location guide using the information about the selected location and the plurality of images of the selected location;
receiving as output of the execution of the at least one model the location guide for the selected location; and
transmitting instructions to a user computer device to display the location guide on the user computer device.

12. The computer-implemented method of claim 11, wherein the location is a geographic location including at least one of a city, a town, a village, a county, a region, an apartment complex, a housing community, a neighborhood, and/or a borough.

13. The computer-implemented method of claim 11, wherein the one or more remote servers provide local information about the selected location.

14. The computer-implemented method of claim 11, wherein the local information includes at least one of demographic information, municipal information, school information, and/or event information.

15. The computer-implemented method of claim 11, wherein the plurality of images of the selected location are provided by a mapping server.

16. The computer-implemented method of claim 11 further comprising enhancing the quality of one or more images of the plurality of images of the selected location.

17. The computer-implemented method of claim 11 further comprising:
receiving a plurality of historical guides and a plurality of information associated with the plurality of historical guides;
training the at least one model to generate guides based upon the plurality of historical guides and the plurality of information associated with the plurality of historical guides; and
storing the at least one model.

18. The computer-implemented method of claim 11 further comprising adding a plurality of links to the location guide, wherein the plurality of links provide access to additional information.

19. The computer-implemented method of claim 18 further comprising hosting the additional information, wherein when activated the links cause the at least one processor to transmit instructions to display one or more items of the additional information on the user computer device.

20. At least one non-transitory computer-readable storage media having computer-executable instructions embodied thereon, wherein when executed by at least one processor of a computer system, the computer-executable instructions cause the processor to:
receive, from a user computer device, a selection of a location;
retrieve, from one or more remote servers, information about the selected location;
retrieve, from one or more remote servers, a plurality of images of the selected location;
execute at least one model to output a location guide using the information about the selected location and the plurality of images of the selected location;
receive as output of the execution of the at least one model the location guide for the selected location; and
transmit instructions to a user computer device to display the location guide on the user computer device.
